(19) United States
(12) Patent Application Publication
(10) Pub. No.: US 2009/0033253 A1
(43) Pub. Date: Feb. 5, 2009

(54) ELECTRIC TRACTION SYSTEM FOR A VEHICLE HAVING A DUAL WINDING AC TRACTION MOTOR

(75) Inventors: James M. NAGASHIMA, Cerritos, CA (US); Brian A. WELCHKO, Torrance, CA (US); George JOHN, Cerritos, CA (US); Sibaprasad CHAKRABARTI, Torrance, CA (US); Milun PERISIC, Torrance, CA (US); Gregory S. SMITH, Woodland Hills, CA (US)

Correspondence Address: INGRASSIA FISHER & LORENZ, P.C. (GM), 7010 E. COCHISE ROAD, SCOTTSDALE, AZ, 85253, US

(73) Assignee: GM GLOBAL TECHNOLOGY OPERATIONS, INC., DETROIT, MI (US)

(21) Appl. No.: 12/120,705

(22) Filed: May 15, 2008

Related U.S. Application Data
(60) Provisional application No. 60/952,742, filed on Jul. 30, 2007.

(51) Int. Cl. H02P 27/06; H02J 7/14

(52) U.S. Cl. 318/139; 320/137

(57) ABSTRACT

An electric traction system for a vehicle having a high voltage battery and a low voltage battery is provided. The system includes an AC electric motor and a double ended inverter system coupled to the AC electric motor. The AC electric motor has a first set of windings and a second set of windings that occupy common stator slots, where the first set of windings and the second set of windings are electrically isolated from each other. The double ended inverter system drives the AC electric motor using energy obtained from the high voltage battery and energy obtained from the low voltage battery. The double ended inverter system utilizes a first inverter subsystem coupled between the first set of windings and the high voltage battery, and a second inverter subsystem coupled between the second set of windings and the low voltage battery.

### CROSS-REFERENCE TO RELATED APPLICATION(S)

This application claims the benefit of U.S. provisional patent application Ser. No. 60/952,742, filed Jul. 30, 2007 (the entire content of which is incorporated by reference herein).

### TECHNICAL FIELD

Embodiments of the subject matter described herein relate generally to an electric traction system. More particularly, embodiments of the subject matter relate to methods and apparatus for matching different battery voltages using a double ended inverter coupled to a dual winding AC traction motor.

### BACKGROUND

In recent years, advances in technology, as well as ever evolving tastes in style, have led to substantial changes in the design of automobiles. One of the changes involves the power usage and complexity of the various electrical systems within automobiles, particularly alternative fuel vehicles, such as hybrid, electric, and fuel cell vehicles.

Many of the electrical components, including the electric motors used in electric and hybrid electric vehicles, receive electrical power from alternating current (AC) power supplies. However, the power sources (e.g., batteries) used in such applications provide only direct current (DC) power. Thus, devices known as power inverters are used to convert the DC power to AC power. In addition, double ended inverter topologies can be used to drive a single AC motor with two DC power sources.

High voltage batteries or battery packs are typically used to provide electric power storage for the electric traction systems in most electric and hybrid electric vehicles. Such a high voltage battery may have a nominal voltage of 100 volts or more. Moreover, batteries are utilized to power other onboard subsystems, such as lighting subsystems, instrumentation subsystems, entertainment subsystems, and the like. For example, many electric and hybrid electric vehicles employ traditional subsystems that are powered by a 12 volt battery. When a vehicle utilizes a low voltage battery and a high voltage battery (e.g., one having a voltage greater than 60 volts), it is important to provide galvanic isolation between the low voltage electrical system and the high voltage electrical system to provide a safe environment in the event of an electrical fault.

### BRIEF SUMMARY

An electric traction system for a vehicle is provided. The system includes an AC electric motor having a stator with winding slots formed therein, a first set of windings wound in the winding slots, and a second set of windings wound in the winding slots. The second set of windings is electrically isolated from the first set of windings. The electric traction system also includes a first inverter subsystem coupled to the first set of windings, and a first DC energy source coupled to the first inverter subsystem. The first inverter subsystem is configured to drive the AC electric motor, and the first DC energy source has a first nominal voltage. The electric traction system also employs a second inverter subsystem coupled to the second set of windings, and a second DC energy source coupled to the second inverter subsystem. The second inverter subsystem is configured to drive the AC electric motor, and the second DC energy source has a second nominal voltage. The first set of windings and the second set of windings are configured as a transformer for voltage matching between the first DC energy source and the second DC energy source.

An electric traction system for a vehicle having a high voltage battery and a low voltage battery is also provided. The system includes an AC electric motor having a first set of windings and a second set of windings that occupy common stator slots of the AC electric motor, the first set of windings and the second set of windings being electrically isolated, and a double ended inverter system coupled to the AC electric motor. The double ended inverter system is configured to drive the AC electric motor using energy obtained from the high voltage battery and energy obtained from the low voltage battery. The double ended inverter system includes a first inverter subsystem coupled to the first set of windings and to the high voltage battery, and a second inverter subsystem coupled to the second set of windings and to the low voltage battery.

An electric traction system for a vehicle having a first energy source with a relatively high nominal DC voltage, and a second energy source with a relatively low nominal DC voltage is also provided. This system includes an AC electric motor having a first set of windings and a second set of windings. The first set of windings is electrically isolated from the second set of windings, and the first set of windings and the second set of windings occupy common stator slots of the AC electric motor to form a transformer for voltage matching between the first energy source and the second energy source. The electric traction system also utilizes a first inverter subsystem coupled to the first energy source and to the first set of windings, and a second inverter subsystem coupled to the second energy source and to the second set of windings. The first and second inverters subsystems are adapted to drive the AC electric motor (individually or collectively). The electric traction system employs a controller coupled to the first inverter subsystem and to the second inverter subsystem. The controller is configured to control the first inverter subsystem and the second inverter subsystem to achieve desired power flow between the first energy source, the second energy source, and the AC electric motor.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a schematic representation of an exemplary vehicle that incorporates an embodiment of a double ended inverter system;

FIG. 2 is a schematic circuit representation of an embodiment of a double ended inverter system suitable for use with an electric or hybrid electric vehicle;

FIG. 3 is a simplified representation of a dual winding AC electric motor suitable for use with the double ended inverter system shown in FIG. 2; and

FIG. 4 is a diagram that illustrates a stator having dual isolated windings.

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

Techniques and technologies may be described herein in terms of functional and/or logical block components, and with reference to symbolic representations of operations, processing tasks, and functions that may be performed by various computing components or devices. For the sake of brevity, conventional techniques related to inverters, AC motor control, electric and hybrid electric vehicle operation, and other functional aspects of the systems (and the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in an embodiment of the subject matter.

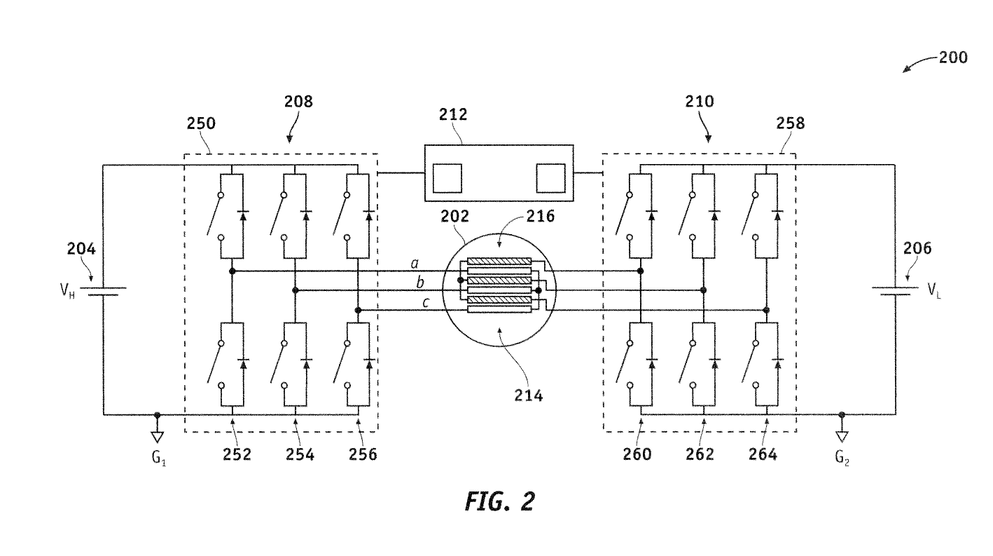

The following description refers to elements or nodes or features being “connected” or “coupled” together. As used herein, unless expressly stated otherwise, “connected” means that one element/node/feature is directly joined to (or directly communicates with) another element/node/feature, and not necessarily mechanically. Likewise, unless expressly stated otherwise, “coupled” means that one element/node/feature is directly or indirectly joined to (or directly or indirectly communicates with) another element/node/feature, and not necessarily mechanically. Thus, although the schematic shown in FIG. 2 depicts one exemplary arrangement of elements, additional intervening elements, devices, features, or components may be present in an embodiment of the depicted subject matter.

There is a need to provide an electric or hybrid electric vehicle with two different batteries (or battery packs) having significantly dissimilar voltages. To satisfy certain safety requirements, such a configuration should provide galvanic isolation to the low voltage side (which is needed for voltages below about 60 volts). The double ended inverter topology described herein provides an interface between a relatively low voltage energy source, a relatively high voltage energy source, and an AC electric motor. Notably, the double ended inverter architecture regulates the flow of energy for the electric traction system of the vehicle without utilizing a DC/DC converter. Elimination of a DC/DC converter is desirable to save cost, weight, and to simplify manufacturing.

One exemplary embodiment can be used in any number of motor vehicles, including, but not limited to an electric, hybrid electric, or fuel cell vehicle with two batteries of widely different voltages. The exemplary embodiment of a doubled ended inverter topology permits a single electric motor to be driven from two different DC power sources. For example, if it is desired to use the double ended topology with a high voltage battery (e.g., greater than 60 volts) and a low voltage battery (e.g., about 12 volts), then galvanic isolation is highly beneficial. This is accomplished by using a motor with two sets of isolated windings occupying the same stator slots. The dual windings act as a transformer to provide both voltage matching and electrical isolation. As described in more detail below, the ratio of turns in the windings is proportional to the voltage ratio of the two batteries.

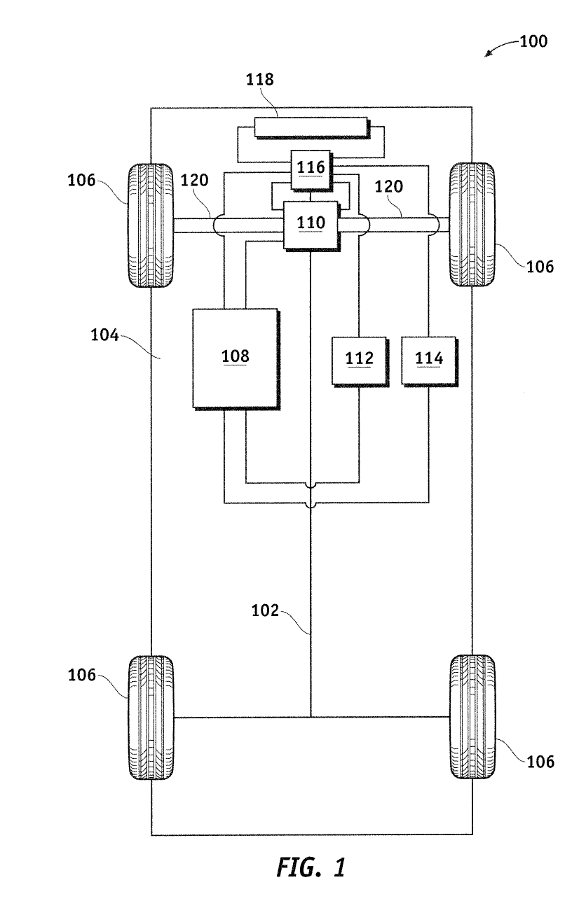

FIG. 1 is a schematic representation of an exemplary vehicle 100 that incorporates an embodiment of a double ended inverter system. Vehicle 100 preferably incorporates an embodiment of a double ended inverter system as described in more detail below. The vehicle 100 generally includes a chassis 102, a body 104, four wheels 106, and an electronic control system 108. The body 104 is arranged on chassis 102 and substantially encloses the other components of vehicle 100. The body 104 and chassis 102 may jointly form a frame. The wheels 106 are each rotationally coupled to chassis 102 near a respective corner of body 104.

The vehicle 100 may be any one of a number of different types of automobiles, such as, for example, a sedan, a wagon, a truck, or a sport utility vehicle (SUV), and may be two-wheel drive (2WD) (i.e., rear-wheel drive or front-wheel drive), four-wheel drive (4WD), or all-wheel drive (AWD). The vehicle 100 may also incorporate any one of, or combination of, a number of different types of engines and/or traction systems, such as, for example, a gasoline or diesel fueled combustion engine, a “flex fuel vehicle” (FFV) engine (i.e., using a mixture of gasoline and alcohol), a gaseous compound (e.g., hydrogen and natural gas) fueled engine, a combustion/electric motor hybrid engine, and an electric motor.

In the exemplary embodiment illustrated in FIG. 1, vehicle 100 is a fully electric or a hybrid electric vehicle having an electric traction system, and vehicle 100 further includes an electric motor (or traction motor) 110, a first DC energy source 112 having a first nominal voltage, a second DC energy source 114 having a second nominal voltage, a double ended inverter system 116, and a radiator 1 18. As shown, first DC energy source 112 and second DC energy source 114 are in operable communication and/or electrically connected to electronic control system 108 and to double ended inverter system 116. It should also be noted that vehicle 100, in the depicted embodiment, does not include a direct current-to-direct current (DC/DC) power converter.

For the embodiments described here, first DC energy source 112 and second DC energy source 114 are batteries (or battery packs) of significantly different voltages. Moreover, first DC energy source 112 and second DC energy source 114 may have different and unmatched current ratings. In this regard, first DC energy source 112 can be a relatively high voltage battery having a nominal operating voltage within the range of about 42-350 volts. For purposes of this description, the exemplary embodiment of vehicle 100 employs a battery that provides more than 60 volts (e.g., 100 volts) for first DC energy source 112. In contrast, second DC energy source 114 can be a relatively low voltage battery having a nominal operating voltage within the range of about 12-42 volts. For purposes of this description, the exemplary embodiment of vehicle 100 employs a 12 volt battery for second DC energy source 114. The techniques and technologies described herein are well suited for use in an embodiment wherein the ratio of the relatively high voltage provided by first DC energy source 112 to the relatively low voltage provided by second DC energy source 114 is at least 8:1.

The motor 110 is preferably a three-phase alternating current (AC) electric traction motor, although other types of motors having a different number of phases could be employed. As shown in FIG. 1, motor 110 may also include or cooperate with a transmission such that motor 110 and the transmission are mechanically coupled to at least some of the wheels 106 through one or more drive shafts 120. The radiator 118 is connected to the frame at an outer portion thereof and although not illustrated in detail, includes multiple cooling channels that contain a cooling fluid (i.e., coolant), such as water and/or ethylene glycol (i.e., antifreeze). The radiator 118 is coupled to double ended inverter system 116 and to motor 110 for purposes of routing the coolant to those components. In one embodiment, double ended inverter system 116 receives and shares coolant with motor 110. In alternative embodiments, the double ended inverter system 116 may be air cooled.

The electronic control system 108 is in operable communication with motor 110, first DC energy source 112, second DC energy source 114, and double ended inverter system 116. Although not shown in detail, electronic control system 108 includes various sensors and automotive control modules, or electronic control units (ECUs), such as an inverter control module (i.e., the controller shown in FIG. 2) and a vehicle controller, and at least one processor and/or a memory which includes instructions stored thereon (or in another computer-readable medium) for carrying out the processes and methods as described below.

FIG. 2 is a schematic circuit representation of an embodiment of a double ended inverter system 200 suitable for use with an electric or hybrid electric vehicle. In certain embodiments, double ended inverter system 116 (shown in FIG. 1) can be implemented in this manner. As depicted in FIG. 2, double ended inverter system 200 is coupled to, and cooperates with, an AC electric traction motor 202, a high voltage battery 204, and a low voltage battery 206. Double ended inverter system 200 generally includes, without limitation: a first inverter subsystem 208 coupled to high voltage battery 204; a second inverter subsystem 210 coupled to low voltage battery 206, and a controller 212 coupled to first inverter subsystem 208 and to second inverter subsystem 210. Although not shown in FIG. 2, respective capacitors may be coupled in parallel with high voltage battery 204 and low voltage battery 206 to smooth current ripple during operation.

Double ended inverter system 200 allows AC electric traction motor 202 to be powered by the different batteries, even though the batteries have significantly different nominal operating voltages. This topology, in conjunction with the dual isolated winding arrangement of AC electric traction motor 202 (described in more detail below), provides voltage matching between high voltage battery 204 and low voltage battery 206. Moreover, this topology, in conjunction with the dual isolated winding arrangement of AC electric traction motor 202, provides galvanic isolation between the electrical subsystems powered by high voltage battery 204 and the electrical subsystems powered by low voltage battery 206. In this context, “galvanic isolation” means that that no current can directly flow between the high voltage side to the low voltage side of double ended inverter system 200. Even though no current can directly flow, energy and power can flow between the sides using other techniques, such as magnetic induction.

Although not illustrated in FIG. 2, AC electric traction motor 202 includes a stator assembly (including the coils) and a rotor assembly (including a ferromagnetic core), as will be appreciated by one skilled in the art. The AC electric traction motor 202, in one non-limiting embodiment, is a three phase motor that includes a first set of windings (or coils) 214 and a second set of windings (or coils) 216. In other words, first set of windings 214 is implemented as a three-phase winding, while second set of windings 216 is implemented as another three-phase winding. The windings in first set of windings 214 are coupled to first inverter subsystem 208, and the windings in second set of windings 216 are coupled to second inverter subsystem 210. It should be appreciated practical embodiments need not always utilize three phases, and that the particular implementation can be modified as needed to accommodate phase numbers other than three.

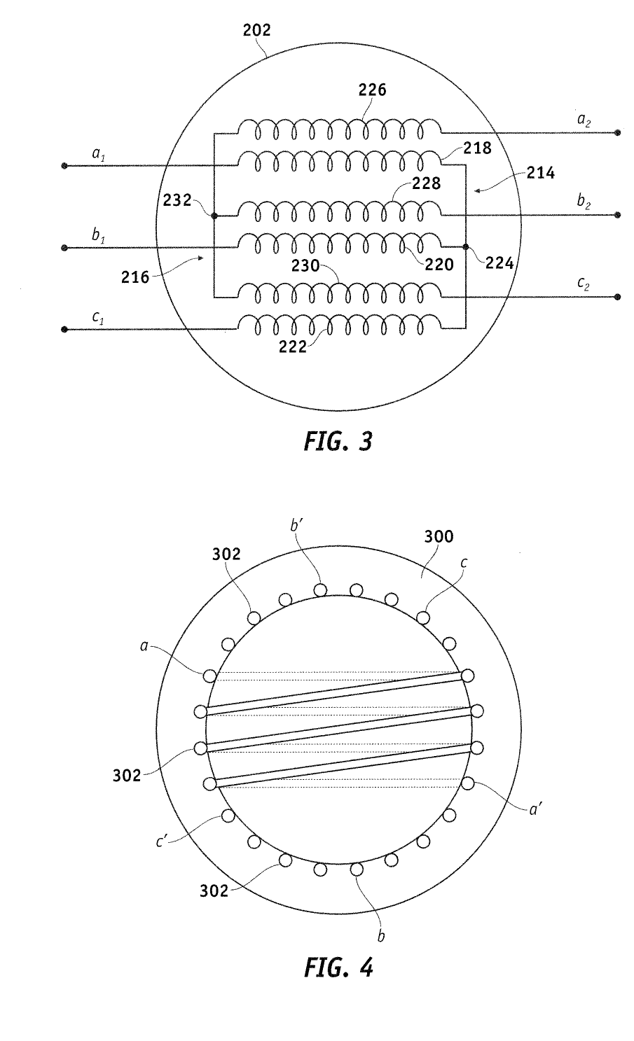

AC electric traction motor 202 is also shown in FIG. 3. Referring to FIG. 2 and FIG. 3, first set of windings 214 includes three windings 218, 220, and 222. One end of winding 218 is coupled to first inverter subsystem 208, and the other end of winding 218 is coupled to (or, as depicted in FIG. 3, corresponds to) a common node 224. Likewise, winding 220 and winding 222 are each coupled between first inverter subsystem 208 and common node 224. Second set of windings 216 includes three windings 226, 228, and 230. One end of winding 226 is coupled to second inverter subsystem 210, and the other end of winding 226 is coupled to (or, as depicted in FIG. 3, corresponds to) a common node 232. Likewise, winding 228 and winding 230 are each coupled between second inverter subsystem 210 and common node 232. In practice, AC electric traction motor 202 may be realized as a six terminal device, and common node 224 and common node 232 may correspond to two different internal connection points in AC electric traction motor 202.

FIG. 3 depicts winding 218 paired with winding 226, winding 220 paired with winding 228, and winding 222 paired with winding 230 because each pair of windings occupies common stator slots of AC electric traction motor 202. In this regard, FIG. 4 is a diagram that illustrates a stator 300 having dual isolated windings. Stator 300 is utilized here for illustrative purposes; an embodiment of AC electric traction motor 202 need not employ the particular configuration and/or winding pattern of stator 300. In FIG. 4, the small circles represent winding slots 302 formed in stator 300, the solid lines between slots 302 represent the front portion of the windings, and the dashed lines between slots 302 represent the rear (hidden) portion of the windings.

For clarity and ease of description, FIG. 4 depicts only one pair of windings, which is associated with phase a of the motor. This pair of windings occupies eight winding slots 302 in stator 300. Notably, both windings in the pair are wound in common winding slots 302, as schematically depicted in FIG. 4. To ensure that the two windings remain electrically isolated, the respective conductors are insulated. Thus, the two windings can be wound in the common winding slots 302 such that the two windings are physically close and adjacent to each other. Referring again to FIG. 3, winding 218 and winding 226 form a first pair that occupies a first group of common slots, winding 220 and winding 228 form a second pair that occupies a second group of common slots, and winding 222 and winding 230 form a third pair that occupies a third group of common slots.

Referring again to FIG. 2, for this embodiment, first inverter subsystem 208 and second inverter subsystem 210 each includes six switches (e.g., semiconductor devices, such as transistors) with antiparallel diodes (i.e., the direction of current through the transistor switch is opposite to the direction of allowable current through the respective diode). As shown, the switches in a section 250 of first inverter subsystem 208 are arranged into three pairs (or legs): pairs 252, 254, and 256. Similarly, the switches in a section 258 of second inverter subsystem 210 are arranged into three pairs (or legs): pairs 260, 262, and 264. A first winding in the set of windings 214 is electrically coupled, at opposing ends thereof, between the switches of pair 252 (in section 250) and a first common node of AC electric traction motor 202. A second winding in the set of windings 214 is coupled between the switches of pair 254 (in section 250) and the first common node. A third winding in the set of windings 214 is coupled between the switches of pair 256 (in section 250) and the first common node. Similarly, a first winding in the set of windings 216 is electrically coupled, at opposing ends thereof, between the switches of pair 260 (in section 258) and a second common node of AC electric traction motor 202. A second winding in the set of windings 216 is coupled between the switches of pair 262 (in section 258) and the second common node. A third winding in the set of windings 216 is coupled between the switches of pair 264 (in section 258) and the second common node.

As mentioned previously, the first set of windings 214 and the second set of windings 216 are electrically insulated from each other. Accordingly, current cannot directly flow between first inverter subsystem 208 and second inverter subsystem 210. In other words, AC electric traction motor 202, first inverter subsystem 208, and second inverter subsystem 210 are suitably configured to provide galvanic isolation between high voltage battery 204 and low voltage battery 206. More specifically, any additional electrical subsystems powered by high voltage battery 204 will be protected and isolated from any additional electrical subsystem powered by low voltage battery 206 (and vice versa).

In practice, first set of windings 214 and second set of windings 216 are suitably configured to function as a transformer, which provides voltage matching between high voltage battery 204 and low voltage battery 206. Such voltage matching allows high voltage battery 204 to recharge low voltage battery 206 through AC electric traction motor. Voltage matching also allows low voltage battery 206 to recharge high voltage battery 204 through AC electric traction motor. Such transformer-based recharging can be regulated and managed by controller 212 while AC electric traction motor 202 is rotating.

The transformer characteristics of AC electric traction motor 202 can be achieved by configuring the number of turns associated with the various windings. Assume, for example, that first set of windings 214 has a first number of turns associated therewith, and that second set of windings 216 has a second number of turns associated therewith. Then, the ratio of the nominal voltage of high voltage battery 204 to the nominal voltage of low voltage battery 206 will be approximately proportional to the ratio of the first number of turns to the second number of turns. The respective power ratings of high voltage battery 204 and low voltage battery 206 may also impact the ratio of the first number of turns to the second number of turns. Accordingly, the number of winding turns in first set of windings 214 and the number of winding turns in second set of windings 216 can be chosen to accommodate the specified nominal voltages and/or power ratings of high voltage battery 204 and low voltage battery 206, respectively.

First inverter subsystem 208 and second inverter subsystem 210 are configured to drive AC electric traction motor 202, individually or collectively (depending upon the particular operating conditions). In this regard, controller 212 is suitably configured to influence the operation of first inverter subsystem 208 and second inverter subsystem 210 to manage power transfer among high voltage battery 204, low voltage battery 206, and AC electric traction motor 202. The controller 212 is responsive to commands received from the driver of the vehicle (e.g., via an accelerator pedal) and provides control signals or commands to section 250 of first inverter subsystem 208 and to section 258 of second inverter subsystem 210 to control the output of sections 250 and 258. High frequency pulse width modulation (PWM) techniques may be employed to control sections 250 and 258 and to manage the voltage produced by sections 250 and 258.

Referring also to FIG. 1, vehicle 100 is operated by providing power to wheels 106 via the AC electric traction motor, which receives its operating energy from high voltage battery 204 and/or low voltage battery 206. In order to power the motor, DC power is provided from high voltage battery 204 and low voltage battery 206 to first inverter subsystem 208 and second inverter subsystem 210, respectively, which convert the DC power into AC power, as is commonly understood in the art. In certain embodiments, if the motor does not require the maximum power output of high voltage battery 204, the extra power from high voltage battery 204 may be used to charge low voltage battery 206 (using the windings of AC electric traction motor 202 as a transformer). Similarly, if the motor does not require the maximum power output of low voltage battery 206, the extra power from low voltage battery 206 may be used to charge high voltage battery 204 (using the windings of AC electric traction motor 202 as a transformer). Of course, under certain operating conditions, controller 212 can be utilized to drive the motor using energy from both energy sources. Another operating mode relates to the ability to “jump start” the system from low voltage battery 206. For example, since most tow trucks only have a 12 volt jump start battery, this topology permits the high voltage battery 204 to be charged from a 12 volt system of a tow truck.

In operation, controller 212 receives a torque command for AC electric traction motor 202, and determines how best to manage the flow of power between high voltage battery 204 and first inverter subsystem 208, and between low voltage battery 206 and second inverter subsystem 210. In this manner, controller 212 also regulates the manner in which first inverter subsystem 208 and second inverter subsystem 210 drive AC electric traction motor 202. Double ended inverter system 200 may utilize any suitable control methodology, protocol, scheme, or technique. For example, certain aspects of the techniques and technologies described in U.S. Pat. Nos. 7,154,237 and 7,199,535 (both assigned to General Motors Corporation) may be employed by double ended inverter system 200. The relevant content of these patents is incorporated by reference herein.

The double ended inverter topology described above can be employed to interface two different energy sources (e.g., batteries) having different and disparate nominal operating voltages for controlled and managed operation in combination with a dual winding AC traction motor of an electric or hybrid electric vehicle. The double ended inverter topology and the isolated windings of the AC traction motor provides galvanic isolation between the low voltage subsystem and the high voltage subsystem of the vehicle.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. An electric traction system for a vehicle, the system comprising:
an AC electric motor comprising:
a stator having winding slots formed therein;
a first set of windings wound in the winding slots; and
a second set of windings wound in the winding slots, the second set of windings being electrically isolated from the first set of windings;
a first inverter subsystem coupled to the first set of windings, the first inverter subsystem being configured to drive the AC electric motor;
a first DC energy source coupled to the first inverter subsystem, the first DC energy source having a first nominal voltage;
a second inverter subsystem coupled to the second set of windings, the second inverter subsystem being configured to drive the AC electric motor; and
a second DC energy source coupled to the second inverter subsystem, the second DC energy source having a second nominal voltage; wherein
the first set of windings and the second set of windings are configured as a transformer for voltage matching between the first DC energy source and the second DC energy source.

2. The electric traction system of claim 1, further comprising a controller coupled to the first inverter subsystem and the second inverter subsystem, the controller being configured to control the first inverter subsystem and the second inverter subsystem to achieve desired power flow between the first DC energy source, the second DC energy source, and the AC electric motor.

3. The electric traction system of claim 2, wherein the controller is configured to control power flow from the first DC energy source to drive the AC electric motor.

4. The electric traction system of claim 2, wherein the controller is configured to control power flow from the second DC energy source to drive the AC electric motor.

5. The electric traction system of claim 2, wherein the controller is configured to control charging of the first DC energy source by the AC electric motor.

6. The electric traction system of claim 2, wherein the controller is configured to control charging of the second DC energy source by the AC electric motor.

7. The electric traction system of claim 1, wherein:
the AC electric motor is a three-phase motor;
the first set of windings is a three-phase winding with three windings, each having a respective first end coupled to the first inverter subsystem, and each having a respective second end coupled to a first common node; and
the second set of windings is a three-phase winding with three windings, each having a respective first end coupled to the second inverter subsystem, and each having a respective second end coupled to a second common node.

8. The electric traction system of claim 1, wherein:
the first set of windings has a first number of turns associated therewith;
the second set of windings has a second number of turns associated therewith; and
the ratio of the first nominal voltage to the second nominal voltage is approximately proportional to the ratio of the first number of turns to the second number of turns.

9. The electric traction system of claim 1, wherein:
the first nominal voltage is a relatively high voltage;
the second nominal voltage is a relatively low voltage; and
the AC electric motor, the first inverter subsystem, and the second inverter subsystem are configured to provide galvanic isolation between the first DC energy source and the second DC energy source.

10. An electric traction system for a vehicle having a high voltage battery and a low voltage battery, the system comprising:
an AC electric motor having a first set of windings and a second set of windings that occupy common stator slots of the AC electric motor, the first set of windings and the second set of windings being electrically isolated; and
a double ended inverter system coupled to the AC electric motor, and configured to drive the AC electric motor using energy obtained from the high voltage battery and energy obtained from the low voltage battery, the double ended inverter system comprising:
a first inverter subsystem coupled to the first set of windings and to the high voltage battery; and
a second inverter subsystem coupled to the second set of windings and to the low voltage battery.

11. The electric traction system of claim 10, wherein the first set of windings and the second set of windings are configured as a transformer for voltage matching between the high voltage battery and the low voltage battery.

12. The electric traction system of claim 10, further comprising a controller coupled to the first inverter subsystem and the second inverter subsystem, the controller being configured to control the first inverter subsystem and the second inverter subsystem to achieve desired power flow between the high voltage battery, the low voltage battery, and the AC electric motor.

13. The electric traction system of claim 10, wherein:
the first set of windings has a first number of turns associated therewith;
the second set of windings has a second number of turns associated therewith;
the high voltage battery has a high nominal voltage;
the low voltage battery has a low nominal voltage; and
the ratio of the high nominal voltage to the low nominal voltage is approximately proportional to the ratio of the first number of turns to the second number of turns.

14. The electric traction system of claim 10, wherein the AC electric motor, the first inverter subsystem, and the second inverter subsystem are configured to provide galvanic isolation between the high voltage battery and the low voltage battery.

15. An electric traction system for a vehicle having a first energy source with a relatively high nominal DC voltage, and a second energy source with a relatively low nominal DC voltage, the system comprising:
an AC electric motor having a first set of windings and a second set of windings, the first set of windings being electrically isolated from the second set of windings, and the first set of windings and the second set of windings occupying common stator slots of the AC electric motor to form a transformer for voltage matching between the first energy source and the second energy source;
a first inverter subsystem coupled to the first energy source and to the first set of windings, the first inverter subsystem being adapted to drive the AC electric motor;
a second inverter subsystem coupled to the second energy source and to the second set of windings, the second inverter subsystem being adapted to drive the AC electric motor; and
a controller coupled to the first inverter subsystem and to the second inverter subsystem, the controller being configured to control the first inverter subsystem and the second inverter subsystem to achieve desired power flow between the first energy source, the second energy source, and the AC electric motor.

16. The electric traction system of claim 15, wherein:
the AC electric motor is a three-phase motor;
the first set of windings is a three-phase winding with three windings, each having a respective first end coupled to the first inverter subsystem, and each having a respective second end coupled to a first common node; and
the second set of windings is a three-phase winding with three windings, each having a respective first end coupled to the second inverter subsystem, and each having a respective second end coupled to a second common node.

17. The electric traction system of claim 15, wherein:
the first set of windings has a first number of turns associated therewith;
the second set of windings has a second number of turns associated therewith; and
the ratio of the relatively high nominal DC voltage to the relatively low nominal DC voltage is approximately proportional to the ratio of the first number of turns to the second number of turns.

18. The electric traction system of claim 15, wherein the AC electric motor, the first inverter subsystem, and the second inverter subsystem are configured to provide galvanic isolation between the first energy source and the second energy source.

19. The electric traction system of claim 15, wherein the ratio of the relatively high nominal DC voltage to the relatively low nominal DC voltage is at least 8:1.

20. The electric traction system of claim 15, wherein:
the relatively high nominal DC voltage is greater than 60 volts; and
the relatively low nominal DC voltage is approximately 12 volts.
